(19) United States
(12) Patent Application Publication
(10) Pub. No.: US 2008/0303694 A1
(43) Pub. Date: Dec. 11, 2008

(54) Traffic control system employing location based services

(76) Inventor: Frank Ury, Mission Viejo, CA (US)

Correspondence Address: Don Carnegie, Suite 5A #540, 5405 Alton Pkwy, Irvine, CA, 92604, US

(21) Appl. No.: 11/810,580

(22) Filed: Jun. 5, 2007

(51) Int. Cl. G08G 1/095

(52) U.S. Cl. 340/907

(57) ABSTRACT

A traffic control system employing location based services is disclosed. The system includes a wireless device disposed in each of a plurality of vehicles, the wireless device operable to log onto a wireless network and transmit the location based services, and a master traffic controller coupled to the wireless network and operable to receive the location based services. A method of traffic control employing location based services includes the steps of (a) logging a vehicle onto a wireless network; (b) computing a network address for the vehicle; (c) receiving location based services data for the vehicle; (d) predicting and optimizing traffic flow based on the received location based services data; (e) switching traffic signals based upon the predicted and optimized traffic flow; and (f) repeating steps (a) through (f) at a pre-determined frequency.

### BACKGROUND OF THE INVENTION

1. Field of the Invention

The present invention generally relates to traffic control and more particularly to a traffic control system employing location based services.

2. Description of Related Art

Conventional traffic control systems employ a vehicle detection system coupled to a master traffic controller that is usually located in a central location. The vehicle detection system includes loop detectors having formed loops of wire buried in the pavement. When charged with electrical current, the loop produces a magnetic field that is changed by the presence of a vehicle. A vehicle detector measures the change in the inductance and sends an electrical signal to the master traffic controller indicating the presence of the detected vehicle. The master traffic controller is operable to switch signal lights in response to the signals received from the vehicle detection system using a loop detector based algorithm. For example, SCOOT (Split Cycle Offset Optimization Technique available from Siemens Traffic Controls, Peek Traffic Ltd., and TRL Limited) is a tool for managing and controlling traffic signals in urban areas. It is an adaptive system that responds automatically to fluctuations in traffic flow through the use of on-street detectors embedded in the road. Other detection systems may employ ultrasonic detectors and video sensors.

Other traffic control systems use an automatic incident detection algorithm. These traffic control systems rely on automatic vehicle identification technology such as used to identify vehicles at tool booths. Individual vehicle travel time data is collected and used to control traffic. It is also known to use traffic counts in the estimation of an Origin/Destination (O/D) trip matrix.

The traffic control systems of the prior art, while meeting their limited objectives, do not provide a traffic control system capable of providing optimized road traffic load balancing based on location based services.

There is therefore a need in the art for a traffic control system that overcomes the disadvantages of the prior art. There is a further need for a traffic control system that employs location based services to provide dynamic and real-time optimized sequencing of traffic signals in a traffic network. There is also a need for a traffic control system that reduces the travel time between a vehicle's current location and its destination. There is a further need for a traffic control system that reduces fuel costs and vehicle emissions. There is also a need for a traffic control system that reduces the need for additional road construction.

### SUMMARY OF THE INVENTION

The traffic control system of the invention comprises a device disposed in each of a plurality of vehicles, each device being wirelessly coupled to a master traffic controller. Each device include means for transmitting location based services to the master traffic controller including a location of the vehicle, a destination of the vehicle, and the speed and direction of the vehicle. The master traffic controller is operable to use data received from the devices as input to traffic flow prediction and optimization algorithms to achieve dynamic and real-time optimized sequencing of traffic signals in a traffic network.

In accordance with one aspect of the invention, a traffic control system employing location based services includes wireless device disposed in each of a plurality of vehicles, the wireless device operable to log onto a wireless network and transmit the location based services, and a master traffic controller coupled to the wireless network and operable to receive the location based services.

In accordance with another aspect of the invention, a method of traffic control employing location based services includes the steps of: (a) logging a vehicle onto a wireless network; (b) computing a network address for the vehicle; (c) receiving location based services data for the vehicle; (d) predicting and optimizing traffic flow based on the received location based services data; (e) switching traffic signals based upon the predicted and optimized traffic flow; and (f) repeating steps (a) through (f) at a pre-determined frequency.

In accordance with yet another aspect of the invention, a method of traffic control employing location based services includes the steps of: (a) logging a vehicle onto a wireless network; (b) computing a network address for the vehicle; (c) receiving location based services data for the vehicle; (d) receiving a vehicle destination; (e) predicting and optimizing traffic flow based on the received location based services data and the vehicle destination; (f) switching traffic signals based upon the predicted and optimized traffic flow; and (g) repeating steps (a) through (f) at a pre-determined frequency.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic representation of a traffic control system in accordance with the invention;

FIG. 2 is a schematic representation of a traffic control device in accordance with the invention; and

FIG. 3 is a flow chart of a traffic control method in accordance with the invention.

### DETAILED DESCRIPTION OF A PREFERRED EMBODIMENT OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

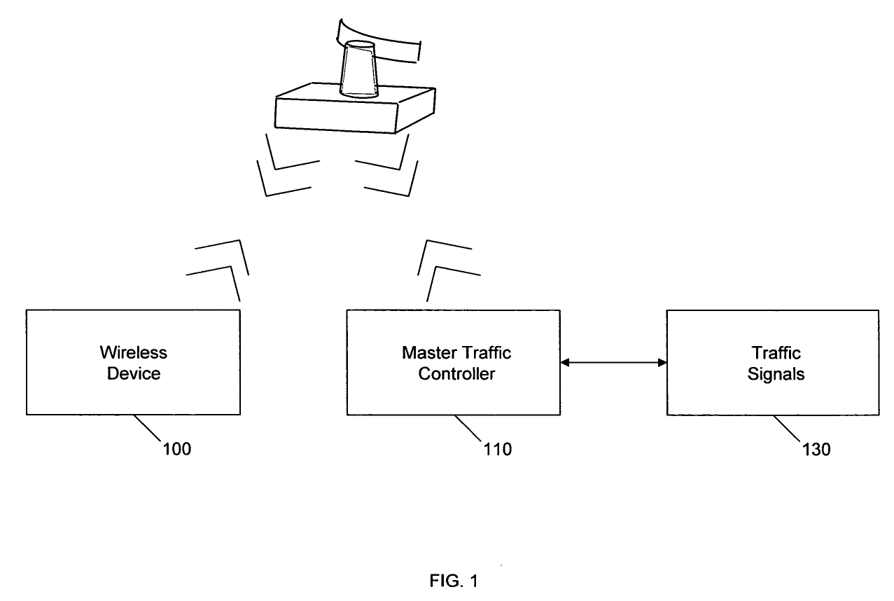

The present invention provides a traffic control system employing location based services. Location based services include Global Positioning System (GPS) data and navigational information, cellular network-based location based services, cellular network-based triangulation, and WiFi triangulation. Location based services provide a master traffic controller 110 (FIG. 1) with vehicle data including the position, speed and direction of travel of the vehicle.

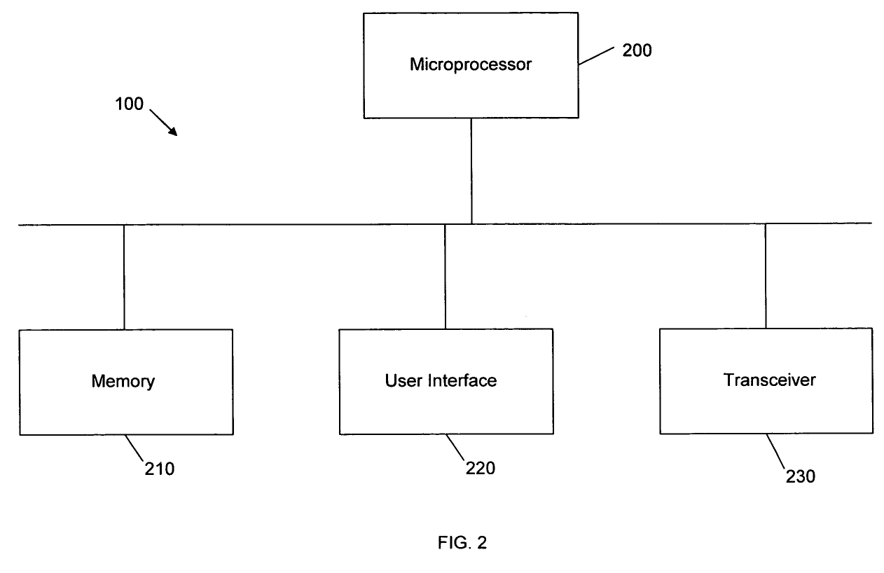

A device 100 is disposed in each of a plurality of vehicles in a given geographical region covered by a wireless network such as a WiFi or WiMax network, or a wireless cellular network. The device 100 includes a microprocessor 200 and a coupled transceiver 230 (FIG. 2) and is operable to wirelessly and securely log onto the wireless network using a protocol such as the Dynamic Host Configuration Protocol (DHCP) upon being powered up. Upon being logged on, the device 100 is assigned a network address. The transceiver 230 is further operable to receive and transmit location based services under control of the microprocessor 200 to the master traffic controller 110, the master traffic controller 110 associating the transmitted location based services with the assigned network address.

The device 100 further comprises a user interface 220 coupled to the microprocessor 200. The user interface 220 is operable to receive user input such as a destination of the vehicle. The destination information is associated with the assigned network address of each device 100 and, together with the location based services, is used by the master traffic controller 110 to predict and optimize traffic flow.

The device 100 may be a low cost standalone device capable of being received in a vehicle cigarette lighter adapter, a PCMCIA card, or implemented in an existing vehicle computer system having location based services.

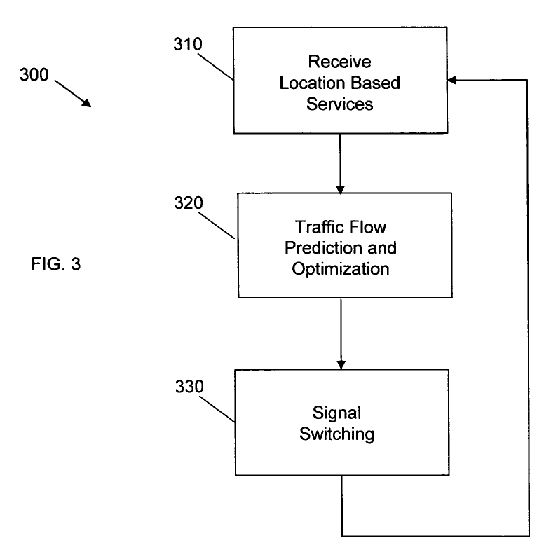

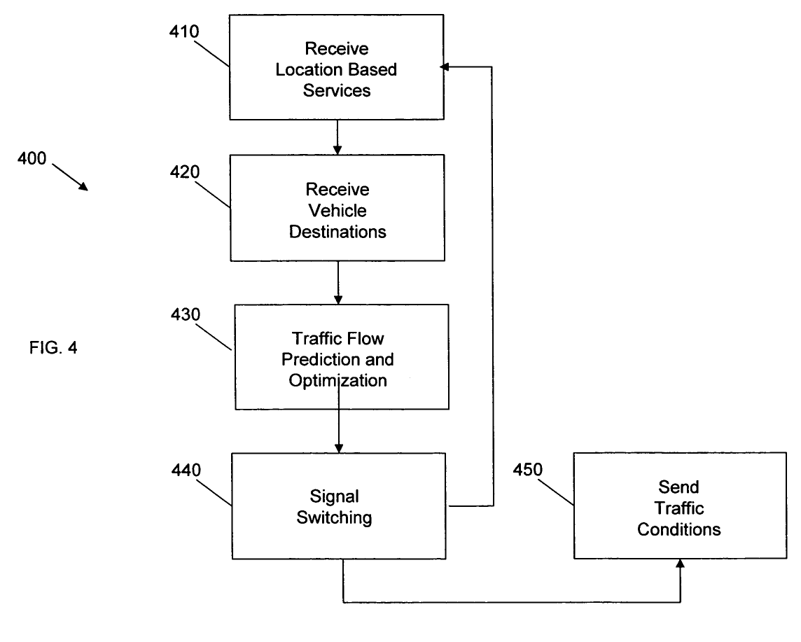

The master traffic controller 110 includes a model of the roads and signalized intersections of the geographical region. The model may include a data path flow model. With reference to FIG. 3, a method 300 in accordance with the invention for predicting and optimizing traffic flow includes a step 310 in which the device 100 logs onto the network. In a step 320 the network address of the device 100 is computed and in a step 330, location based services data, including the vehicle destination, is received. Traffic flow is predicted and optimized in a step 330 and in a step 340 signal switching is effected (in either a wireless or wired manner) based upon the results of step 330 to provide road balancing. Traffic flow is predicted and optimized in step 330 using algorithms employing queuing subroutines and simultaneous linear equations. Steps 340 and 350 are executed by the master traffic controller 110 with a frequency sufficient to take into account vehicles logging onto the network in step 310 and changing location based services data received in step 330.

The traffic control system employing location based services of the invention provides a traffic control system operable to dynamically and in real-time predict and optimize traffic flow by receiving location based services data from each of a plurality of vehicles. The received data is used by a master traffic controller to switch signals at signalized intersections in response to changing traffic conditions represented by changing location based services data.

It is apparent that the above embodiments may be altered in many ways without departing from the scope of the invention. For example, the master traffic controller may employ algorithms based on other predictive methods. Further, various aspects of a particular embodiment may contain patentably subject matter without regard to other aspects of the same embodiment. Still further, various aspects of different embodiments can be combined together. Accordingly, the scope of the invention should be determined by the following claims and their legal equivalents.

What is claimed is:

1. A traffic control system employing location based services comprising:
a wireless device disposed in each of a plurality of vehicles, the wireless device operable to log onto a wireless network and transmit the location based services; and
a master traffic controller coupled to the wireless network and operable to receive the location based services.

2. The traffic control system of claim 1, wherein the wireless network represents a traffic flow network.

3. The traffic control system of claim 1, wherein the location based services includes vehicle data.

4. The traffic control system of claim 3, wherein the data includes a vehicle location.

5. The traffic control system of claim 3, wherein the data includes a vehicle direction of travel.

6. The traffic control system of claim 3, wherein the data includes a vehicle speed.

7. The traffic control system of claim 1, wherein the master traffic controller is operable to predict and optimize traffic flow based upon the received location based services.

8. The traffic control system of claim 1, wherein the wireless device is operable to transmit a user supplied vehicle destination to the master traffic controller.

9. The traffic control system of claim 8, wherein the master traffic controller is operable to predict and optimize traffic flow based upon the received location based services and the vehicle destination.

10. A traffic control method employing location based services comprising the steps of:
(a) logging a vehicle onto a wireless network;
(b) computing a network address for the vehicle;
(c) receiving location based services data for the vehicle;
(d) predicting and optimizing traffic flow based on the received location based services data;
(e) switching traffic signals based upon the predicted and optimized traffic flow; and
(f) repeating steps (a) through (f) at a pre-determined frequency.

11. The method of claim 10, further comprising receiving a destination data from each vehicle and using the destination data in step (d).

12. The method of claim 10, wherein each vehicle comprises a wireless device operable to log onto the wireless network.

13. The method of claim 10, wherein steps (b) through (e) are executed by a master traffic controller operable to represent a traffic network.

14. The method of claim 10, wherein the location based services includes vehicle data.

15. The method of claim 14, wherein the vehicle data includes a vehicle location.

16. The method of claim 14, wherein the vehicle data includes a vehicle direction.

17. The method of claim 14, wherein the vehicle data includes a vehicle speed.

18. A traffic control method employing location based services comprising the steps of:
(a) logging a vehicle onto a wireless network;
(b) computing a network address for the vehicle;
(c) receiving location based services data for the vehicle;
(d) receiving a vehicle destination;
(e) predicting and optimizing traffic flow based on the received location based services data and the vehicle destination;
(f) switching traffic signals based upon the predicted and optimized traffic flow; and
(g) repeating steps (a) through (f) at a pre-determined frequency.

19. The method of claim 18, wherein each vehicle comprises a wireless device operable to log onto the wireless network.

20. The method of claim 18, wherein the location based services includes vehicle data including a vehicle location, direction and speed.
